(19) United States
(12) Patent Application Publication
(10) Pub. No.: US 2005/0081318 A1
(43) Pub. Date: Apr. 21, 2005

(54) Scraper and safety sheath

(76) Inventor: Wayne Alexander Boutilier, Halifax (CA)

Correspondence Address: Wayne Boutilier, 3610 Windsor Street, Halifax, B3K 5G8, CA

(21) Appl. No.: 10/688,626

(22) Filed: Oct. 20, 2003

(51) Int. Cl. B26B 3/06

(52) U.S. Cl. 15/236.01; 30/169; 30/339

(57) ABSTRACT

An improved scraper (20), utilizing a metal blade (75), to scrape debris from a variety of hard and soft surfaces. It features an integrated mechanism providing a flexible locking tab arm (21) and locking tab head (22) securing the unit to a sheath (40) designed to receive the scraper (20) and the locking tab head (22) within a locking tab head hole (41). The scraper (20) provides a removable blade storage cover (60) exposing a blade storage cavity (27) providing storage for spare blades. A flexible blade locking tab (21) to secure a metal blade (75) for use. A sheath (40) that mates with complimentary tools such as, and not limited to, for example, mops, dust-mops, brooms etc. via a pair of flexible mounting arms (44) that conform to the radius of such tools.

### CROSS-REFERENCED TO RELATED APPLICATIONS

Not Applicable

### FEDERALLY SPONSORED RESEARCH

Not Applicable

### SEQUENCE LISTING

Not Applicable

### BACKGROUND

1. Field of Invention

This invention relates to scraping devices used for scraping any hard surfaces clear of debris.

2. Prior Art

Scrapers have been used for removing debris from hard surfaces using a variety of different designs. Some have been utilized in the janitorial, painting, window cleaning field(s) or household use. All primarily function to scrape debris from a variety of hard or soft surfaces.

A limited few have been adopted for use in the janitorial, window cleaning and painting professions due to limitations in design, size, and degree of effectiveness.

Different scrapers offer different features. Some have long handles or short. Some have the ability to retract the blade as is the case with U.S. Pat. No. 4,558,517 to Gringer (1985). Some have wider blades as well as narrow blades as is the case with U.S. Pat. No. 6,351,888 to Brown, Brown (2002). As well, some have a place to store replacement blades within the handle itself. There are some that use a combination of the features above and more as is the case with U.S. Pat. No. 6,442,784 to Bilger (2002). A variety of materials have been used to manufacture scrapers such as plastic, metal, wood etc.

Although useful, most have fallen short of the ideal tool for use in the janitorial, window cleaning and painting profession. Retractable blade mechanisms fail to perform after repeated use and no longer retract easily, and do not provide a stable platform for scraping. Frequent use causes the ‘gumming up’ of the retracting mechanism by debris trapped or deposited within the retracting mechanism and renders the scraper useless and dangerous to store in a pocket or on one's person.

Rusting of the handle is common if the scraper handle is made of a metal. Storage of the replacement blades is at best only a feature of a few and not all. Replacing the blades is dangerous because of cutting oneself while replacing the used blade due to side load designs or designs that use screws making it awkward to replace due to cumbersome design. A variety of scraper designs use screws to secure the blade making replacement of the blade time consuming and more complicated than needed by requiring the use of a screwdriver or other tool to remove the blade.

A major problem that plagues scraping devices is where to store the tool while not in use, safely and conveniently, for future use. Many persons in the related fields of janitorial, painting and window cleaning field have often misplaced or lost scrapers while performing scraping tasks.

### OBJECTS AND ADVANTAGES

Accordingly, several objects and advantages of this invention are as follows;
a) to store a scraper safely when needed via a sheath;
b) to have a sheath mated with tools that compliment the primary and secondary task of mopping and scraping a floor of debris, sweeping and scraping a floor of debris, window cleaning and scraping the glass of debris or painting a room and scraping debris off of walls or paint off of glass or other surfaces;
c) to provide an easily operated integrated mechanism to release and to secure blades without any additional part(s) or mechanism(s) screws, fly bolts etc;
d) to lock a scraper in place within the sheath via an integrated mechanism to provide a secure fit to prevent accidental release of the scraper;
e) to provide storage of the replacement blades; and
f) to facilitate attaching and detaching the unit for use with any desired complementary tool such as a mop handle, dustmop handle, painters pole, broom handle or window cleaner's pole.

The full scope of the advantages will be apparent from a consideration of the drawings and ensuing description.

### SUMMARY

The disclosed invention comprises of a scraper with a cavity designed specifically for blade storage and a sheath designed specifically to be mated with a variety of handles. The scraper is designed to hold a blade for use, to store replacement blades and is held securely in place via a locking tab which is an integrated part of the scraper design which mates with an accompanying sheath.

The sheath is designed to receive the scraper and provide safe storage for the scraper while not in use and is also designed to mate with or attach to a variety of different poles, mop handles, broom handles, painter's pole or window cleaners pole.

### DRAWINGS

FIG. 1 shows the perspective view of the complete unit comprising of the scraper and sheath mated with each other.

FIG. 2 shows the perspective view of the scraper and the sheath.

FIG. 3a shows the perspective view of the scraper unit with a blade uninstalled.

FIG. 3b shows the underside of the scraper with the accompanying cover.

FIG. 4a shows the front view of the sheath.

FIG. 4b shows the side view of the sheath.

FIG. 4c shows the top view of the sheath.

FIG. 4d shows the bottom view of the sheath.

FIG. 4e shows the perspective view of the sheath

FIG. 5a shows the front view of the scraper and sheath.

FIG. 5b shows the side view of the scraper and sheath.

FIG. 5c shows the bottom view of the scraper and sheath before mounting on a pole.

FIG. 5d shows the bottom view of the scraper and sheath mounted to a pole.

FIG. 6a shows the side cutaway view of the scraper with blade installed.

FIG. 6b shows the side cutaway view of the scraper with the blade removed and blade storage cover removed.

FIG. 7 shows the side view of the scraper and sheath.

FIG. 8a shows the side view of the blade storage cover.

FIG. 8b shows the top view of the blade storage cover.

FIG. 8c shows the front view of the blade storage cover.

FIG. 8d shows the perspective view of the blade storage cover.

FIG. 9a shows the top view of the scraper and blade storage cover.

FIG. 9b shows the bottom view of the scraper and blade storage cover.

FIG. 10 shows the perspective view of the blade storage scraper, blade(s) and sheath.

FIG. 11 shows the scraper and sheath mounted on a pole.

### REFERENCE NUMERALS

20 scraper handle
21 locking tab arm
22 locking tab head
23 blade locking tab
24 blade shaft
25 blade secure head
26 blade locking tab head
27 blade storage cavity
28 locking tab arm base
29 blade storage cover rails
30 scraper stop feature
40 safety sheath
41 locking tab head hole
42 cleaning relief feature
43 blade stop feature
44 mounting arms
45 sheath scraper hole
60 blade storage cover
61 blade cover locking tab
75 blade
76 blade locking tab hole
90 pole

### DETAILED DESCRIPTION AND PREFERRED EMBODIMENT

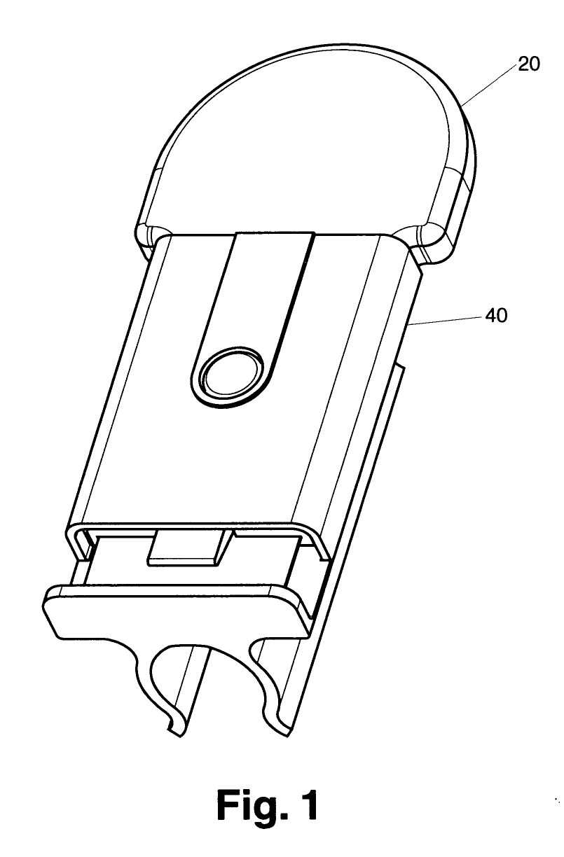

A preferred embodiment of the invention is illustrated in FIG. 1-11. In the preferred embodiment, all parts consist of injection molded plastic parts providing the needed strength and required flexibility.

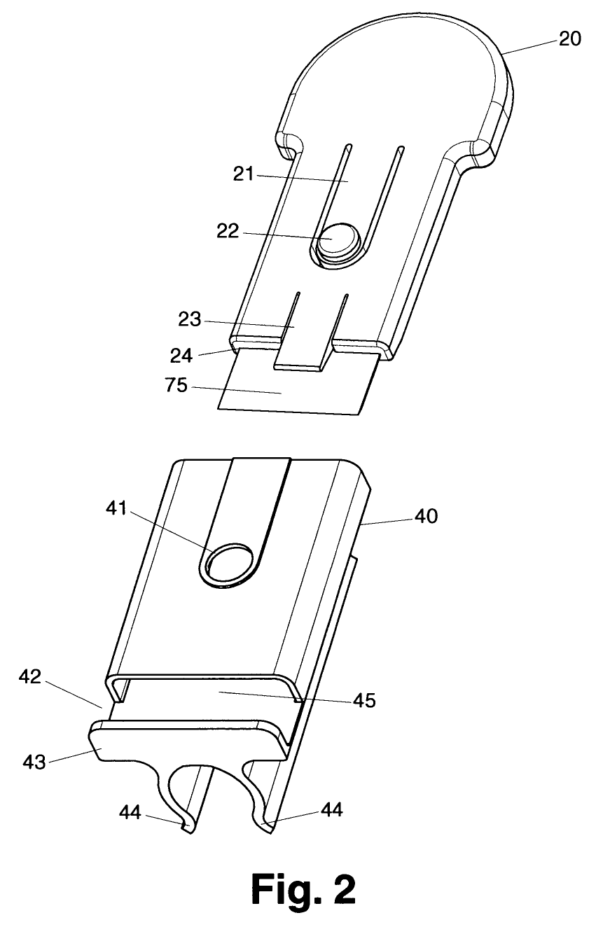

FIG. 1 shows the scraper 20 and the sheath 40 mated with each other. In FIG. 2 both parts, the scraper handle 20 and the sheath 40, are shown separated from each other showing various features related to each individual part.

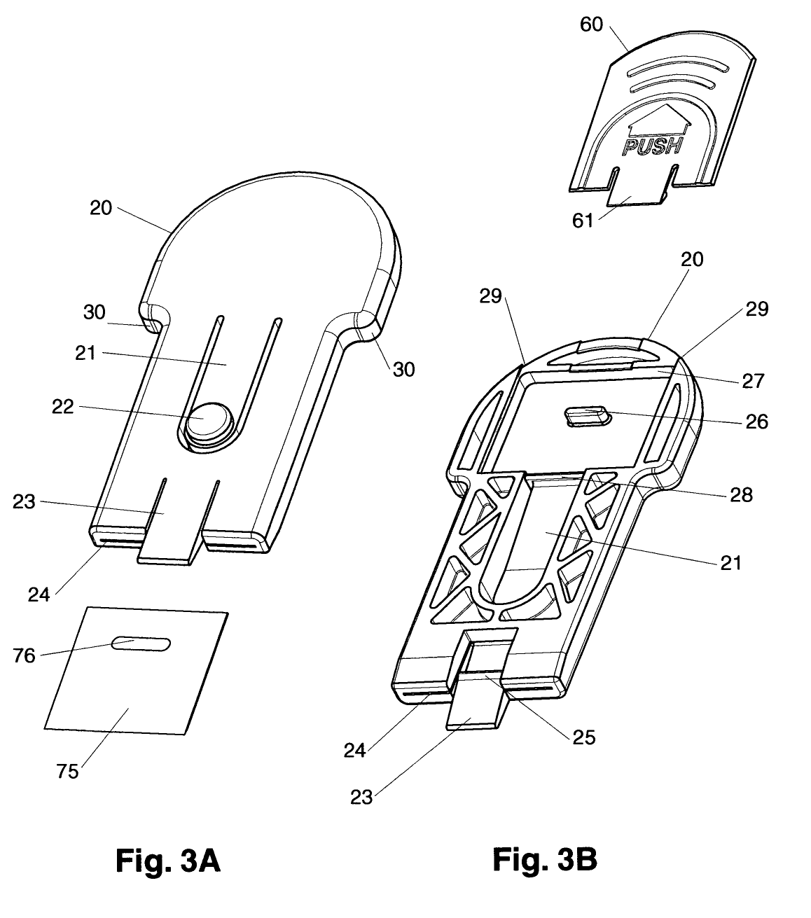

In FIG. 3a and FIG. 3b the scraper handle 20 is shown with the blade 75 and the blade storage cover 60 apart from the scraper handle 20. FIG. 3a shows the top perspective view and FIG. 3b shows the bottom perspective view. The scraper 20 consists of several features molded into one solid piece with an additional part, the blade storage cover 60, also made of plastic, designed to slide in and out of the blade storage cover rails 29. The blade 75, made of metal sharpened at one end and a blade locking tab hole 76 located near the base of the blade 75. The parts that are integrated in the scraper handle 20 itself, consist of a locking tab arm 21, locking tab head 22, blade locking tab 23, blade shaft 24, blade secure head 25, blade locking tab head 26, blade storage cavity 27, locking tab arm base 28, blade storage cover rails 29 and the scraper stop feature 30.

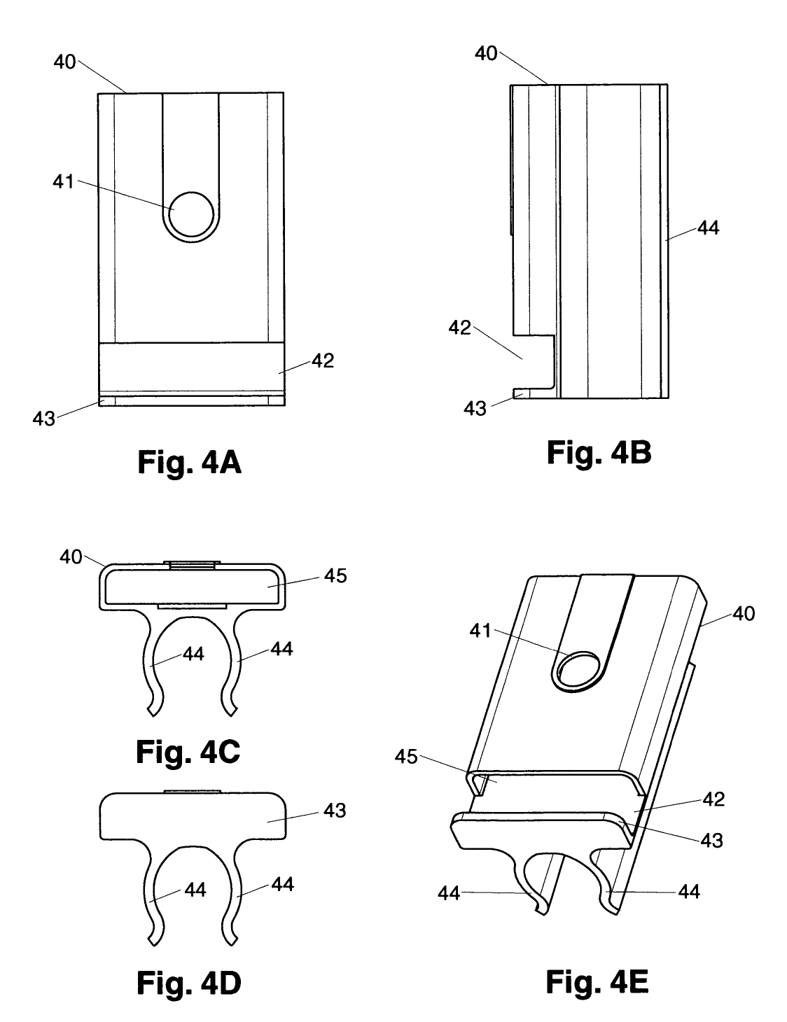

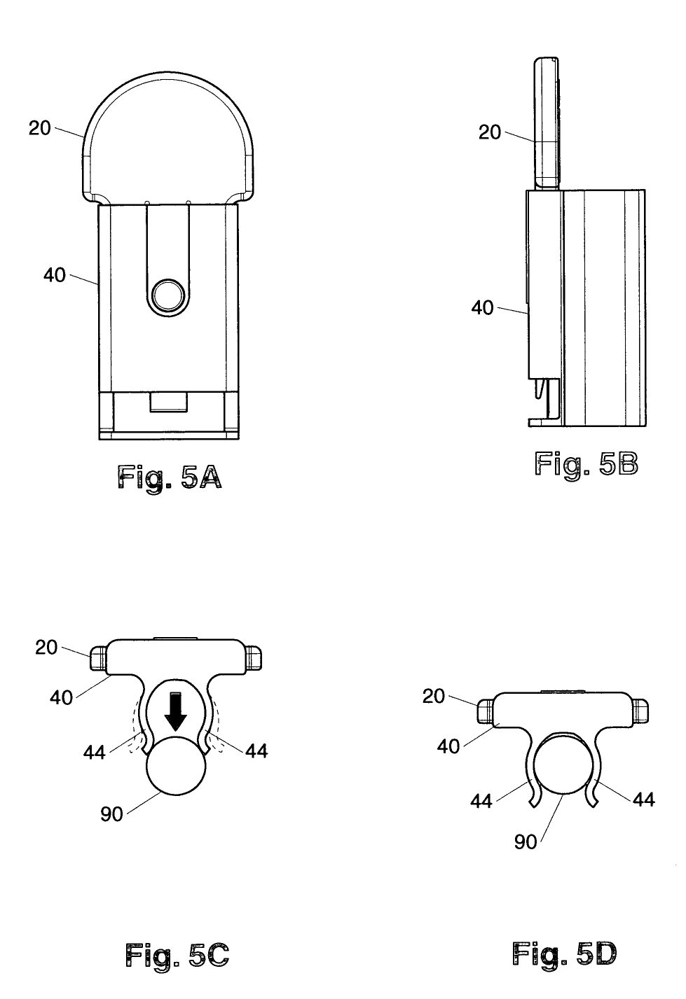

FIG. 4a, 4b, 4c, 4d and 4e show the sheath 40 in the front view (FIG. 4a), side view (FIG. 4b), top view (FIG. 4c), bottom view (FIG. 4d), perspective view (FIG. 4e). The sheath 40 consists of several features molded into one piece. The parts of the sheath 40 are the locking tab head hole 41, cleaning relief feature 42, blade stop feature 43, mounting arms 44, sheath scraper hole 45. When the sheath 40 and scraper handle 20 are mated, shown in FIG. 5a (front view) and FIG. 5b (side view) they can be placed on a pole 90, shown in FIGS. 5c and 5d, or handle with a radius of 0.85 of an inch (2.159 cm) to 1 inch (2.54 cm) by forcing the mounting arms 44 to flex and conform to the radius of a handle or pole.

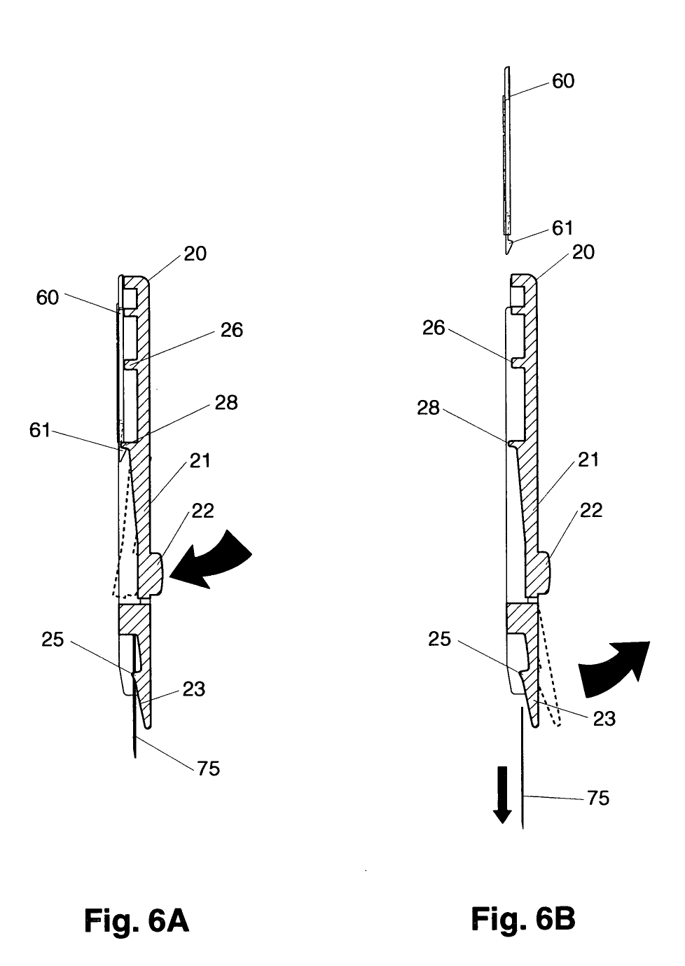

FIG. 6a shows a cutaway side view of the scraper 20 and blade storage cover 60 (in place) and the integrated features the locking tab arm 21, locking tab head 22 (flexed position shown in dashed lines) and the blade 75 inserted and held in place by the blade locking tab head 25. FIG. 6b shows a cutaway side view of the scraper 20 and the blade storage cover 60 (removed), the blade locking tab 23 and the blade secure head 25 (flexed position shown in dashed lines) and the blade 75 removed.

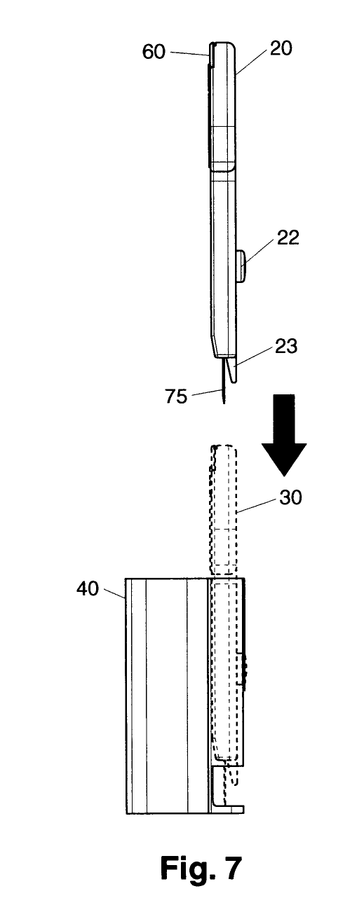

FIG. 7 shows the the scraper 20 with the storage blade cover 60 and blade 75 installed before and after mated with the sheath 40 (mated in dashed lines).

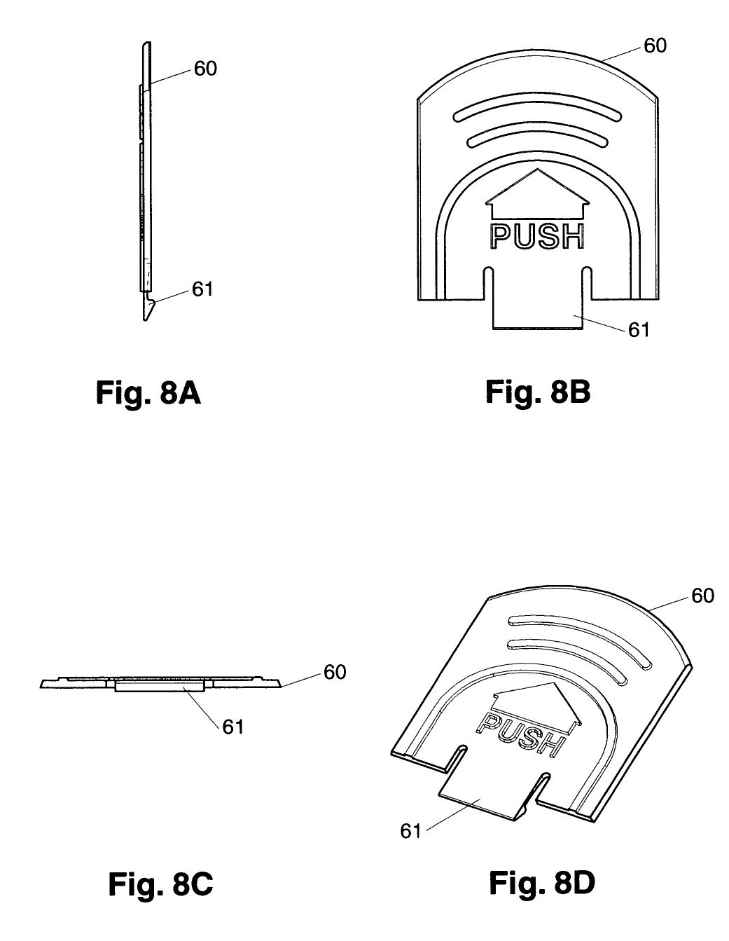

FIGS. 8a, 8b, 8c and 8d show the blade storage cover 60 in the side, top, front and perspective views. The blade storage cover features a blade cover locking tab 61.

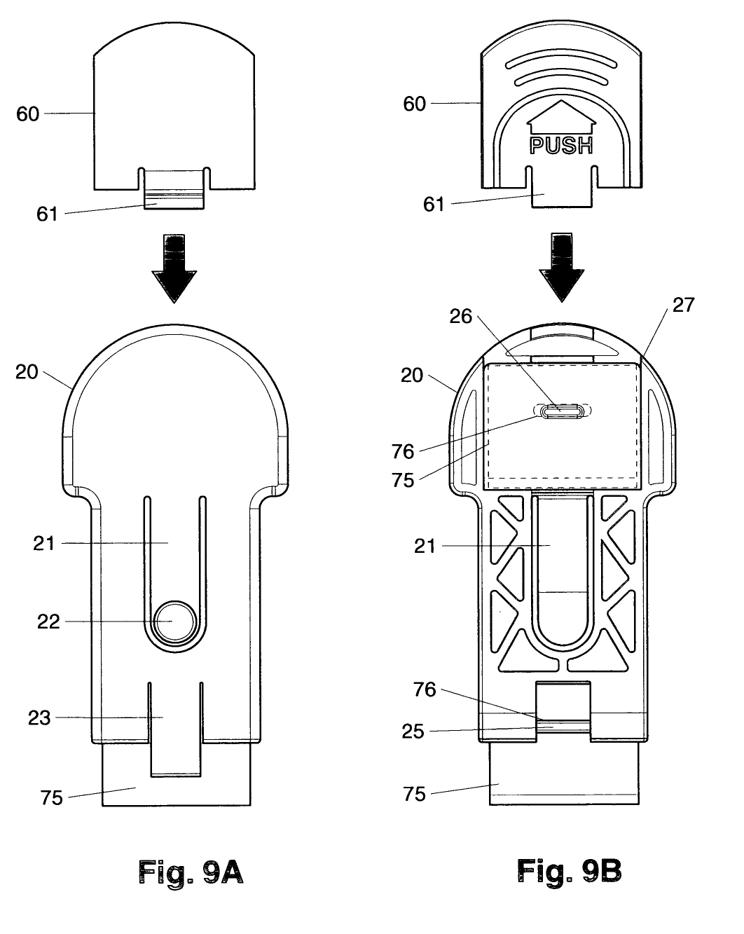

FIG. 9a shows the top view of the scraper 20 and blade storage cover 60 apart from the scraper 20 and the blade 75 installed within the scraper 20 and held in place by the blade locking tab 23. FIG. 9b shows the bottom view of the scraper 20 and the blade storage cover 60 apart from the scraper 20 and blade 75 installed and held in place by the blade secure head 25 and shows the blade secure head 25 penetrating the blade locking tab hole 76. FIG. 9b also details the blade storage cavity 27 and the blade secure head 25 and a blade 75 (shown in dashed lines) occupying the blade storage cavity 27 and secured by the blade secure head 25.

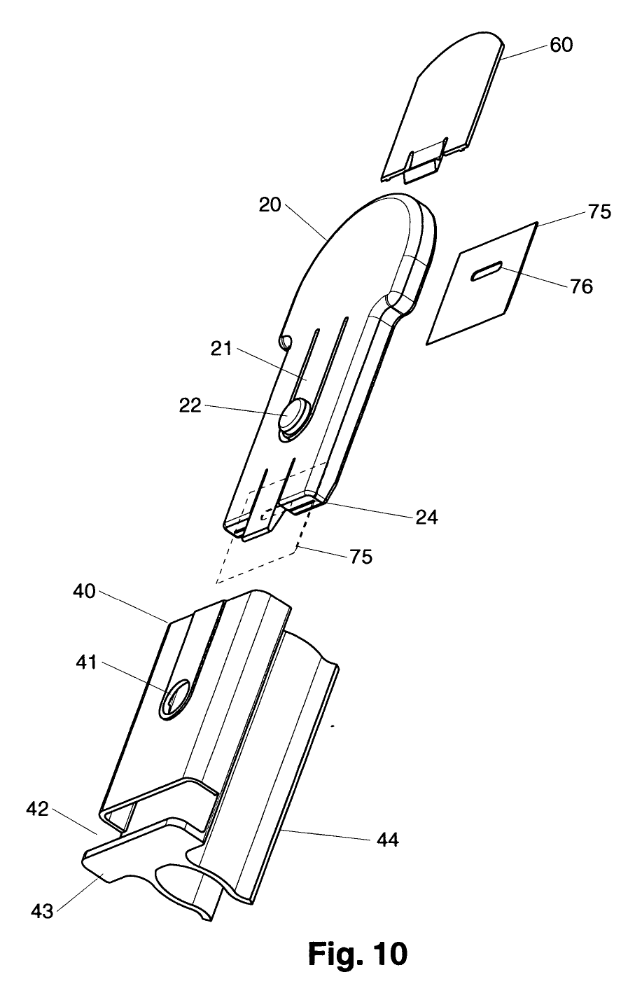

FIG. 10 shows the my design in a side perspective view of all parts apart from each other. The blade storage cover 60, the scraper 20, blade 75 (shown in dashed lines installed), an additional blade 75 (shown in solid lines apart from the storage cavity), and the sheath 40.

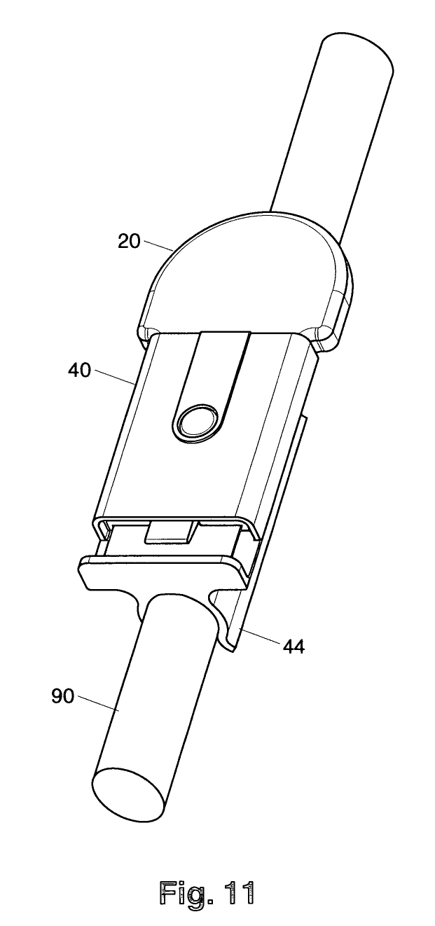

FIG. 11 shows the entire unit together and mated with a pole 90.

Operation—Preferred Embodiment

Various scrapers have been used in the past to perform scraping tasks usually requiring the user to have this sharp tool on their person, whether in a pocket or pouch. In the case of having it in one's pocket, a danger exists in hurting oneself if the blade is exposed to the user's flesh. In the case of a pouch, one is required to secure it to oneself on a belt to keep it handy for use. My design does not require one to carry a sharp tool on one's person. It provides a safety sheath 20, shown in FIGS. 4c, 4d and 4e shows a set of mounting arms 44 that are an integrated part of the sheath 40 to allow attachment on various complementary tools of the trade such as, mop handles, brooms, dust-mops, painter's poles, window cleaning poles or any pole complementary to scraping tasks.

The scraper handle 20 can be mated and locked in place when it is inserted into the sheath scraper hole 45, FIG. 4c, which runs the length of the sheath 40 (FIG. 4e) to provide housing for the scraper 20 (FIG. 3a) when not in use. The locking tab arm 21 and locking tab head 22 work in conjunction to provide enough tension to secure the scraper 20 so that accidental ejection of the scraper 20 is prevented whereas, purposeful retrieval of the scraper 20 is facilitated by depressing the locking tab head 22 (shown in FIG. 6a) and removing the scraper 20 from the sheath 40.

The locking tab arm 21 flexes (FIG. 6a) to allow the locking tab head 22 to be inserted and ejected from the locking tab head hole 41 and sheath 40 (FIG. 4e) thus making purposeful ejection of the scraper handle 20.

A similar method of design is incorporated in the blade locking tab 23 (FIG. 6b) and blade locking tab head 25 to allow easy installation and ejection of new and used blades. To remove a dull blade 75 (shown in FIG. 6b) one simply has to pull on the blade locking tab 23 causing the blade locking tab head 25 to be clear of the blade locking tab hole 76 (FIG. 3a) and is easily removed from the blade shaft 24 (FIG. 3a). The method of replacing a blade 75 is to insert the blade 75 into the blade shaft 24 (FIG. 3a), pushing it until the blade locking tab head 25 (FIG. 6b) is inserted into the blade locking tab hole 76.

Storage of the blades is incorporated in the design of the scraper handle 20 by means of a blade storage cavity 27 (FIG. 3b) located on the underside of the scraper handle 20 and covered by a blade storage cover 60. Removal of the blade storage cover 60 exposes the blade storage cavity 27 to allow storage of new blades. Blades are held in place by a blade secure head 26 which penetrate the blade locking tab hole 76 (FIG. 3a) to prevent excessive movement of the blades while in storage. Removal of the blade storage cover is performed by lifting the blade cover locking tab 61 (FIG. 3b) and sliding the blade storage cover 60 from the blade storage cover rails 29 until the blade storage cavity 27 is fully exposed. One simply puts blades into the blade storage cavity 27 and replaces the blade storage cover 60.

Once the scraper handle 20 is equipped with a new blade 75 you can mate it with the sheath 40 (FIG. 2) and attach the sheath 40 to your preferred tool of choice by forcing the mounting arms 44 to flex (FIG. 5c, 5d), conforming to the radius of your preferred tool (FIG. 11).

Advantages

From the description above, a number of advantages of my scraper and sheath design become evident:
a) My design allow the user to store the scraper safely when needed via a sheath without the hassle of storing the tool on his or her person.
b) The scraper and sheath when mated with tools that compliment the secondary task of scraping a hard surface of debris will provide a convenient location for easy retrieval and storage.
c) My design provides a lock that keeps the scraper in place within the sheath via an integrated mechanism to provide a secure fit to prevent accidental release of the scraper but, purposeful retrieval of the scraping tool.
d) My design has an easily operated integrated mechanism to release and to secure blades without any additional part(s) or mechanism(s) screws, fly bolts etc. will facilitate ease of use for the user without additional tools to secure the blade.
e) My design provides storage of replacement blades.
f) My design facilitates attaching and detaching the unit for use with any desired complementary tool such as a mop handle, dustmop handle, painters pole, broom handle or window cleaner's pole.
g) My design provides a cleaning relief feature to facilitate easy clean-up if the sheath and scraper have become dirty from debris.

FIG. 5b shows the complete unit installed on a pole or handle for easy retrieval and storage.

### CONCLUSION, RAMIFICATIONS, AND SCOPE

The reader can clearly see that the invention has many advantages and features that past devices have fallen short of the ideal tool for scraping in fields such as janitorial, window cleaning and painting. It has the additional advantages in that
it provides containment and secures a scraper and mates with complimentary tools for example mops, brooms, dust-mops, painter's pole etc.;
it provides an easily operated integrated flexible mechanism to release and secure the scraper when needed;
it provides an integrated flexible mechanism that provides a secure hold on the blade and is easily operated eliminating the need for additional parts such as screws, fly bolts etc.;
it simplifies the removal of used blades and simplifies easy installation of new blades.

The scope of the invention is not limited to the preferred embodiment contained in this document. The above description should not be construed as limitations on the scope of the invention but, rather as an exemplification of one preferred embodiment. Many other variations are possible. For example, a solution to affixing the sheath to a handle would be to rivet or screw the sheath to a mop handle, broom etc. Glue or sticky tape could be used to adhere the sheath to a mop handle, broom etc. A clamping device could be employed to secure the sheath to a mop handle, broom etc. As is the case with the scraper the locking tab arm could be placed in alternative locations different than that of the center of the scraper body to provide a secure lock to the sheath. The scraper may have more than one flexible locking tab arm. Alternative body styles could be employed to accomplish the same result of the scraper being placed into the sheath. Storage of the blades could be placed on the sheath rather than the scraper handle.

Thus the scope of the invention should be determined by the claims and their legal equivalents, rather than by the examples given.

1. An improved hand held scraper handle for accomplishing the task of scraping debris from hard or soft surfaces, comprising:
(a) a hand held scraper handle having at one end a handle section for gripping and at the opposite end
(b) a shaft section formed to receive within the said hand held scraper handle
(c) a blade secured with the assistance of
(d) an integrated catch and release mechanism forming a complete tool for the purpose of performing scraping tasks and
(e) said shaft section of the hand held scraper handle having the means to release said blade by means of said integrated catch and release mechanism and
(f) said hand held scraper handle section having means to store an undetermined amount of spare blades within
(g) a cavity of sufficient length, width and depth to store an undetermined amount of spare blades which features
(i) a storage cover that attaches and detaches from the hand held scraper handle section for the purpose of enclosing and securing within said cavity said spare blades and
(j) said hand held scraper handle having means to attach and detach with the assistance of a integrated catch and release mechanism from
(k) a sheath formed to receive said hand held scraper handle and
(l) said sheath having means to release the scraper working in conjunction with said integrated catch and release mechanism and
(m) said sheath having sufficient length, width and depth to provide a means to store said scraper within said sheath for the purpose of storage and retrieval and
(n) said sheath providing a means to facilitate cleaning of said sheath and
(n) said sheath having means to attach and detach from a pole with the assistance of
(o) a set of mounting arms that conform to the radius of a pole, whereby said hand held scraper handle and said sheath can be coupled with each other and attaches as one unit with a pole for the purpose of storage and retrieval.

2. An improved hand held scraper handle for accomplishing the task of scraping debris from hard or soft surfaces, comprising:
a scraper handle and blade having means to attach and detach from
a sheath and said sheath having the means to attach and detach to a radius.
